(19) United States
(12) Patent Application Publication
(10) Pub. No.: US 2004/0216127 A1
(43) Pub. Date: Oct. 28, 2004

(54) Method and apparatus for accelerating web services

(75) Inventors: Anindya Datta, Atlanta, GA (US); Kaushik Dutta, Atlanta, GA (US)

Correspondence Address: GARDNER GROFF, P.C., PAPER MILL VILLAGE, BUILDING 23, 600 VILLAGE TRACE, SUITE 300, MARIETTA, GA, 30067, US

(73) Assignee: Chutney Technologies, Atlanta, GA (US)

(21) Appl. No.: 10/241,059

(22) Filed: Sep. 10, 2002

(51) Int. Cl. G06F 9/46

(52) U.S. Cl. 719/313

(57) ABSTRACT

Apparatuses and methods for accelerating web services. In accordance with a first embodiment of the present invention, the apparatus and method of the present invention are incorporated into consumer-side logic, such as, for example, in Web portal logic, and operate to accelerate web services by reducing processing overhead on the consumer side. In accordance with a second embodiment of the present invention, the apparatus and method of the present invention are incorporated into provider-side logic, such as, for example, in logic located at a Web Service Provider (WSP), and operate to accelerate web services by reducing processing overhead on the provider side.

### TECHNICAL FIELD OF THE INVENTION

The present invention relates to communications and, more particularly, to accelerating Web services provided over a network by Web Service Providers (WSPs).

### BACKGROUND OF THE INVENTION

Web services are services provided over a network, such as the Internet, by a Web Service Provider (WSP). For example, a WSP may be a server at a particular address in the network that provides weather information to users that access the server through requests for some type of information provided by the WSP. Another example of a WSP is a server at a particular address in the network that provides stock quote information to users upon request. Generally, Web services are services that enable enterprises to share applications with customers, partners, and suppliers, for example, regardless of hardware or software environment.

Web services are typically characterized by a set of standards that specify the manner in which Web services can be found, described and invoked over the Internet. Web services are expected to provide numerous benefits to enterprises, including improved business collaboration and reduced time-to-market for new applications. However, before such benefits can be fully realized, a number of issues must be resolved. One such issue is that of the performance and scalability of Web services. The basic idea behind Web services is to allow applications to communicate using standards-based technologies. Several key initiatives have emerged that are aimed at Web services standards, including Simple Object Access Protocol (SOAP), Web Services Description Language (WSDL), and Universal Description, Discovery, and Identification (UDDI). These standards are all based on extensible markup language (XML).

SOAP is a communication protocol used to exchange information in a decentralized, distributed environment. A SOAP message includes the contents of the SOAP message and an envelope that describes the nature of the contents and how to process them. Because SOAP allows XML messages to be sent over a network, it provides the advantage of interoperability and platform independence.

UDDI is a repository-based registry service that provides for the automated lookup of Web services. UDDI can be thought of as the yellow pages for Web services. UDDI is layered over a SOAP message and assumes that requests and responses are UDDI objects sent as SOAP objects.

WSDL is a template contained in each SOAP request that specifies particular properties of the particular Web service being requested, such as what a particular service can do, where the corresponding Web server resides in the network (information initially obtained from the UDDI), and how to invoke the particular service being requested.

An example of the use of these standard protocols in serving requests will now be described with reference to FIG. 1. In this example, the application is a portal application that provides users with a variety of services that can be personalized based on the user's preferences. Specifically, three different WSP servers, 1, 2 and 3, are shown, which provide news, stock quotes and weather, respectively. FIG. 1 demonstrates the manner in which a user's request for a portal page is serviced using the SOAP/WSDL/UDDI Web services paradigm.

The “CLIENT” 4 can be thought of as the user's Internet Service Provider (ISP), which has, upon receiving a request from the user, invoked the portal server 5. Invocation of the portal server 5 by the client 4 is represented by the arrow 9. When a particular service has been requested for a first time, a portal application executed by the portal server 5 queries the UDDI registry 7 to locate the service of interest, as indicated by the arrow 8 between the UDDI registry 7 and the portal server 5. This normally is an optional, one-time operation that enables the portal server 5 to retrieve the location of the WSP associated with the requested service from the UDDI registry 7. In other words, once the WSP address associated with a particular service has been retrieved from the UDDI registry 7 by the portal server 5, the WSP address is saved by the portal server 5 for future requests.

Once the portal server 5 knows the location of a WSP, when an initial request for the service is made by the client 4, the portal server 5 obtains the corresponding WSDL document from the corresponding WSP without having to access the UDDI registry 7. The portal server 5 retrieves the WSDL document from the corresponding WSP through a separate message exchange (not shown) and stores the WSDL document at the portal origin site so that it can be used for subsequent invocations of the particular service.

At run-time, i.e., when the portal application is executed in response to a user request, the request is served in the following manner. First, the user requests the portal page, which causes an instance of the portal application to be executed by the portal server 5. This step is represented in FIG. 1 by arrow 9 from the client 4 to the portal server 5. The portal server 5 then generates the portal page (not shown). Assuming for example purposes that the user requests a portal page which includes objects provided by each of the WSPs 1, 2 and 3, a service request call will be issued by the portal server 5 to each of the WSPs 1, 2 and 3, as indicated by arrows 11, 12 and 13, respectively. The Web service request calls enable the portal sever 5 to retrieve objects from each of the WSPs 1, 2 and 3 that are needed to build the user's portal page with the appropriate information.

Each communication with one of the Web Service Providers 1, 2 and 3 occurs via a SOAP message. The double ended arrows 11, 12 and 13 indicate that a SOAP response is sent back to the portal server 5. When the portal server 5 receives the SOAP responses, it generates the user's portal page, as indicated by the arrow 14 from the portal server 5 to the client 4.

FIG. 2 shows the details involved in the process performed by the portal server 5 when generating a request to be sent to a WSP, such as one of the WSPs 1, 2 or 3 shown in FIG. 1. The tasks performed at the portal server 5 will be referred to herein as the consumer-side process. The tasks performed at the WSPs 1, 2 and 3 will be referred to herein as the provider-side process.

The consumer-side process begins when the portal server 5 executes the portal application invoked as a result of a communication received by the portal server 5 from the client 4 (FIG. 1). The portal application typically is a script that the portal server 5 executes in response to the user's request. This particular set of tasks corresponds to the “Call Object Invocation” process, which is represented in FIG. 2 by the circle 19. The Call Object Invocation process 19 includes the tasks of instantiating the SOAP client object 21, reading the WSDL file (previously obtained from the UDDI 7) 22, obtaining the method and parameters that correspond to the service being requested 23, and arranging this information into a service method call 24.

The service request call is then wrapped into a SOAP message by a SOAP serializer/deserializer 25 at the portal server 5 that serializes the service method call into a SOAP-XML-formatted message 26 (hereinafter referred to as a “SOAP-XML message”). Once the SOAP-XML message has been generated, the SOAP-XML message is wrapped into a hypertext (HTTP) message 27 by an HTTP encoder/decoder 28 so that it is suitably formatted for transmission over the network to the WSP. The HTTP request is then sent over the network to the SOAP server (FIG. 3) of the corresponding WSP, where the provider-side process is performed. When the response sent from the WSP to the portal server 5 is received by the portal server 5, the SOAP response is extracted from the HTTP response (i.e., the HTTP layering is stripped away) by the decoder 28, as indicated by circle 46. The SOAP deserializer 25 then deserializes the SOAP response, as indicated by circle 47.

The provider-side process will now be described with reference to FIG. 3, which is a block diagram of a typical WSP. In FIG. 3, the circles 31, 33 and 35 correspond to components that perform the provider-side process and the circles 32, 34, 36, 37, 41, 43, 44 and 42 correspond to processes performed by components 31, 33 and 35. The term “component”, as that term is used herein, is intended to mean hardware, software executed by a processor, a combination of software executed by a processor and hardware, firmware, etc.

When the WSP receives the HTTP-wrapped SOAP request 30, an HTTP Request Handler 31 channels 32 the request to the SOAP Dispatcher 33 associated with the requested service. The SOAP Dispatcher 33 then sends 34 the request to the HTTP and SOAP Encoder/Decoder 35, which strips off the HTTP and SOAP wrappers and deserializes 36 the SOAP request. Once the SOAP request has been decoded, the service method that was contained in the SOAP request is invoked 37.

Once invoked, the service method is executed by service method component 38. When the service method is executed by the service method component 38, the initial request is serviced in order to obtain the information requested by the portal server 5. Once this response has been obtained, it is sent 41 to be serialized, wrapped into a SOAP-XML response and wrapped into an HTTP response, as indicated by circle 42. The encoded response is then passed back to the SOAP Dispatcher 33 associated with the response, which then passes it 43 to the HTTP Request Handler 31. The HTTP Request Handler 31 selects the correct channel 44 over which the SOAP-XML, HTTP-encoded response 45 is to be sent back to the portal server 5.

It should be noted that all of these processes are performed for each user request. In addition, many users are typically being handled by the same portal server 5 at any given time. Likewise, many requests are typically being handled by a WSP at any given time. Therefore, a large amount of processing overhead is required at the consumer side and at the provider side to (1) generate a request or response, (2) wrap the request or response into a SOAP message, which requires string-processing steps, and (3) wrap the SOAP message into an HTTP request, which requires traversal of a network protocol stack (e.g., Transmission Control Protocol/Internet Protocol (TCP/IP)). This processing overhead increases service response time latency to the user.

It would be desirable to decrease the amount of processing overhead required to provide Web services in order to accelerate Web services. A reduction in processing overhead would result in a reduction in the response-time latency. Accordingly, a need exists for a method and apparatus that enable processing overhead to be decreased when providing Web services, thereby reducing response time latency and accelerating Web services.

### SUMMARY OF THE INVENTION

The present invention provides apparatuses and methods for accelerating web services. In accordance with a first embodiment of the present invention, the apparatus and method of the present invention are incorporated into consumer-side logic, such as, for example, in Web portal logic, and operate to accelerate web services by reducing processing overhead on the consumer side. In accordance with a second embodiment of the present invention, the apparatus and method of the present invention are incorporated into provider-side logic, such as, for example, in logic located at a Web Service Provider (WSP), and operate to accelerate web services by reducing processing overhead on the provider side.

In accordance with the first embodiment, the apparatus comprises call object invocation logic that receives a request for a web service and converts the request into a service method call. Storage engine logic then receives information from the call object invocation logic associated with the service method call and uses at least a portion of the information to determine whether a response to the request is stored in a memory element. If the storage engine logic determines that the response is stored in the memory element, the storage engine logic causes the response to be read from the memory element. Thus, the processing overhead associated with having to serialize and package a service method request, forward it to a WSP, wait for a response from the WSP, and then unpackage and decode the service method request is eliminated.

The method of the first embodiment comprises receiving a request for a web service and converting it into a service method call and utilizing information relating to the service method call to determine whether a response to the request is stored in a memory element. If a determination is made that a response to the request is stored in the memory element, the response is read from the memory element.

In accordance with the second embodiment, the apparatus is located at a WSP. The apparatus comprises request processing logic that receives a service method request and decodes the service method request, and storage engine logic that uses at least a portion of the information to determine whether a response to the service method request is stored in a memory element. If the storage engine logic determines that the response is stored in the memory element, the storage engine logic causes the response to be read from the memory element. Thus, the processing overhead associated with having to unpackage and decode the service method request and then serialize and package the service method response once the request has been processed is eliminated.

The method in accordance with the second embodiment comprises receiving a service method request for a web service at a Web Service Provider (WSP) and decoding the service method request, utilizing information relating to the decoded service method request to determine whether a response to the request is stored in a memory element, making a determination as to whether a response to the request is stored in the memory element, and if so, reading the response from the memory element.

These and other features and advantages of the present invention will become apparent from the following description, drawings and claims.

### BRIEF DESCRIPTION OF THE DRAWINGS

FIG. 1 is a pictorial illustration of a typical Web services environment.

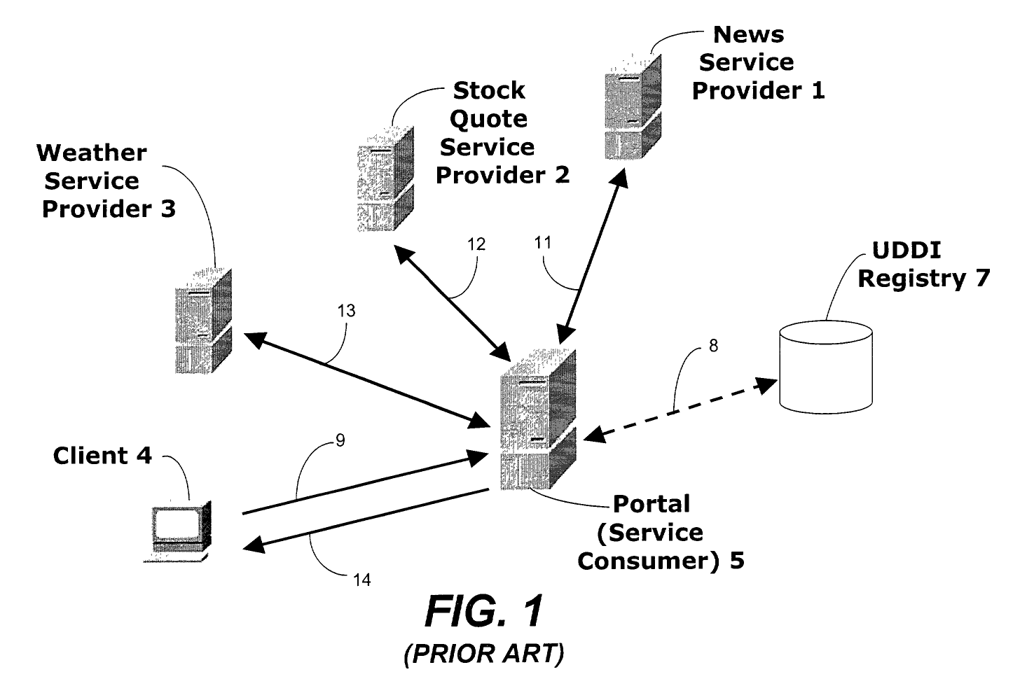

FIG. 2 is a block diagram illustrating the components and processes of a typical Web portal application that consumes Web services.

FIG. 3 is a block diagram illustrating the components and processes of a typical WSP.

FIG. 4 is a block diagram illustrating the components and processes utilized in accordance with an example embodiment of the present invention to eliminate certain consumer-side processing steps shown in FIG. 2.

FIGS. 5A and 5B are flow charts illustrating methods of the present invention performed at the consumer-side embodiment of FIG. 4.

FIG. 6 is a block diagram illustrating the components and processes utilized in accordance with an example embodiment of the present invention to eliminate certain provider-side processing steps shown in FIG. 2.

FIGS. 7A and 7B are flow charts illustrating methods of the present invention performed at the provider side embodiment of FIG. 6.

FIG. 8 is a block diagram illustrating the components and processes utilized in accordance with an example embodiment of the present invention to eliminate certain provider-side processing steps shown in FIG. 3.

FIG. 9 is a block diagram illustrating the components and processes utilized in accordance with another example embodiment of the present invention to eliminate certain provider-side processing steps shown in FIG. 3.

FIG. 10 is a flow chart illustrating one method of the present invention that may be performed at the consumer-side in accordance with the embodiments shown in FIGS. 4 and 6 to further reduce processing overhead.

### DETAILED DESCRIPTION OF PREFERRED EMBODIMENTS

As discussed above, the performance and scalability of Web services currently are limited due to delays in the end-to-end service response times. The specific delays currently associated with Web services can be attributed to the following: (1) each Web service request/response must be packaged, or wrapped, as a SOAP message before being transmitted over the network, which requires string processing operations, which add delays; (2) each Web service invocation requires network communications, which requires traversal of a network protocol stack (e.g., TCP/IP), which adds to the service response time latency; (3) the increased bandwidth requirements due to the fact that SOAP is a text-based protocol makes the delays associated with (1) and (2) even greater; (4) each Web service request/response must be extracted from a SOAP message, which requires parsing the SOAP message, which also adds delays; and (5) Once a request/response is extracted from a SOAP message, the application server handling the request or response uses the contained data to create the programmatic objects that are necessary to serve the end user's request, which is costly in terms of both processing overhead and input/output (I/O) operations, which contribute to the delays.

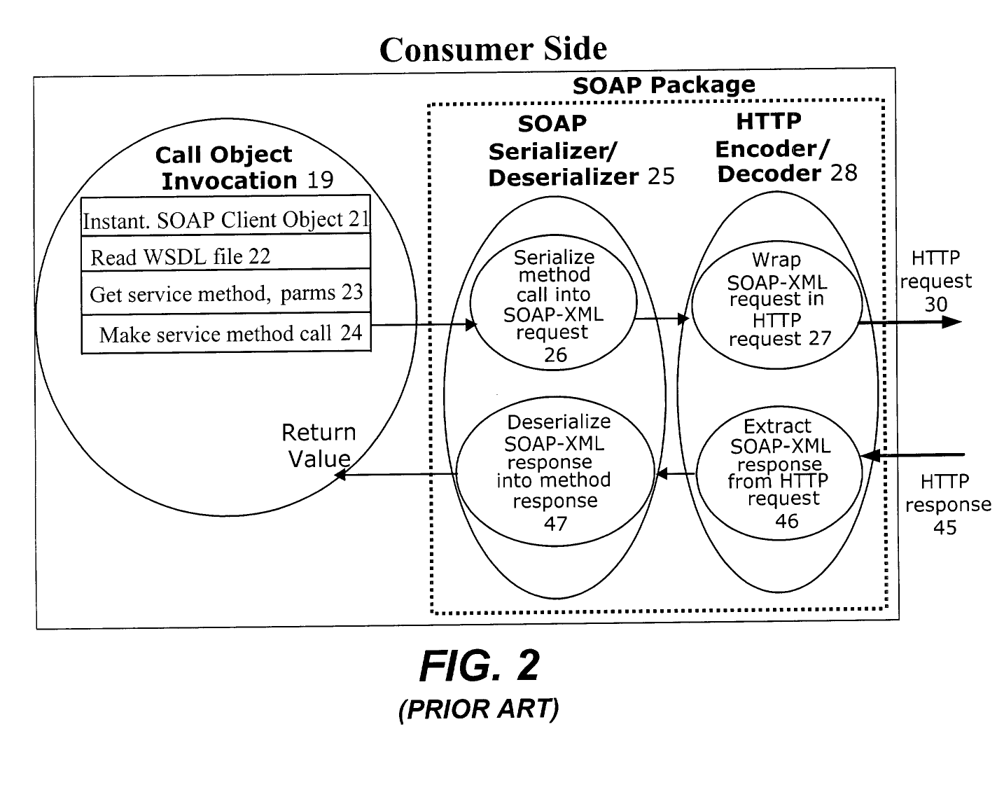

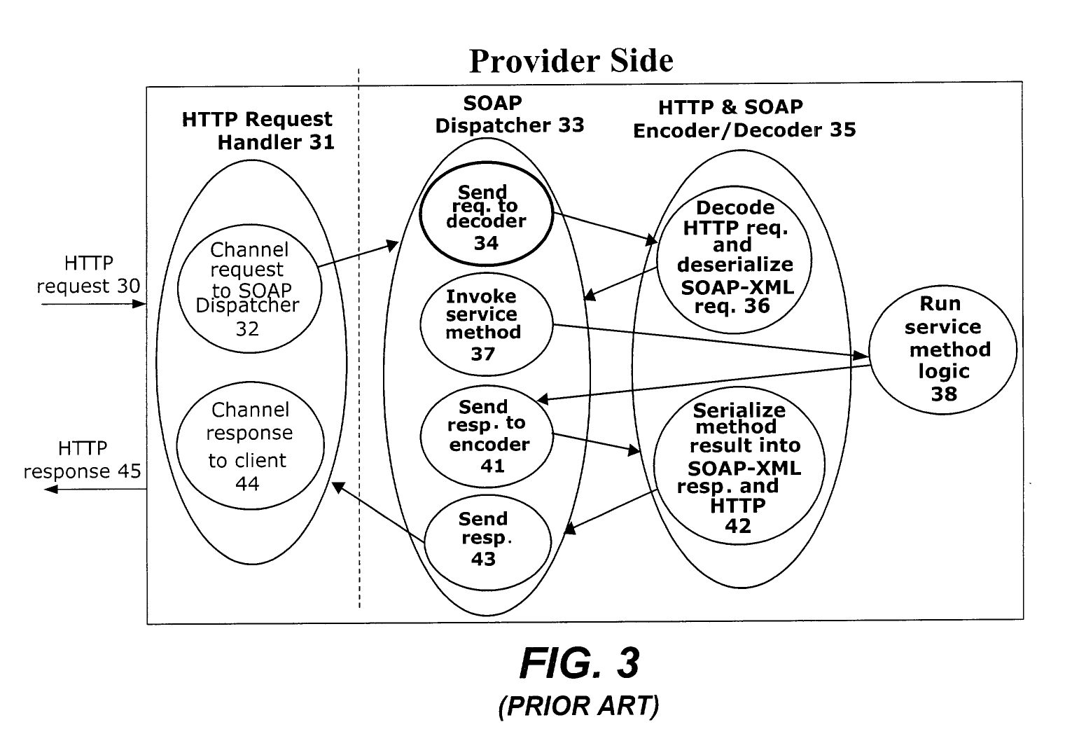

As indicated above, currently each of the steps shown in FIG. 2 must occur for each request for a Web service. Thus, the more services that an application consumes, the greater the potential for bottlenecks. Another important fact is that these delays occur in addition to the usual delays that occur in serving a request, such as object creation and destruction and cross-tier communication costs. Thus, the step of generating the requested object at the WSP, which is part of running the service method logic 38 (FIG. 3), may involve several layers of nested callouts and creation of numerous programmatic objects, which further increase the response-time latency. Furthermore, requests may be served via nested Web service calls. For example, the step of generating the requested object (Call Object Invocation 19, FIG. 2) may require that a Web service request be serviced by one WSP and that the corresponding response be sent to another WSP, and so on.

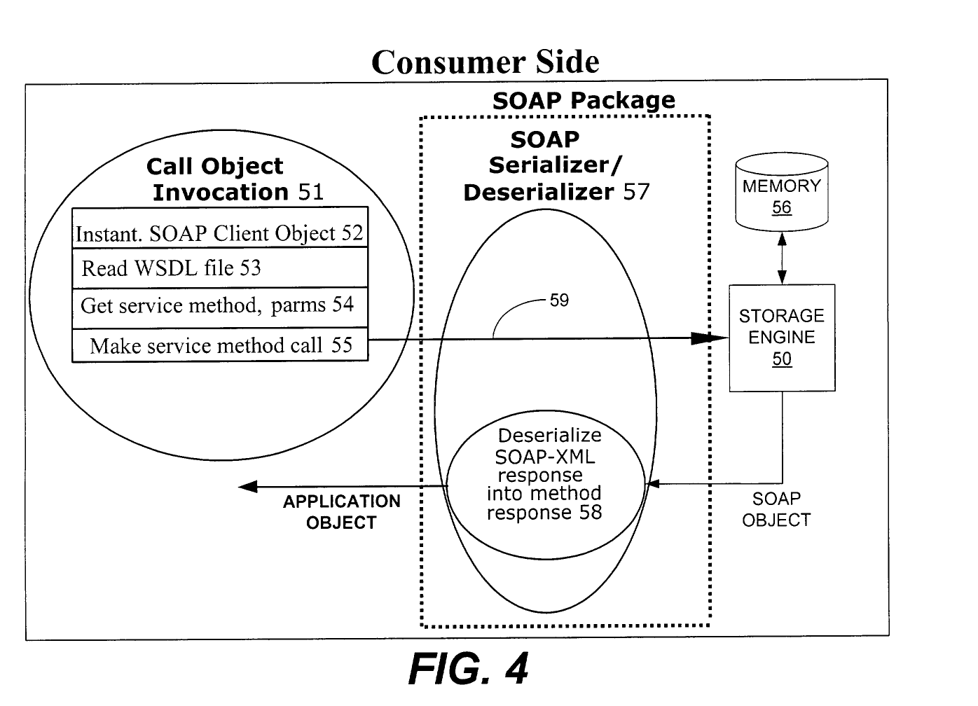

In accordance with the present invention, processing overhead associated with WEB services has been greatly reduced, thereby reducing delays and accelerating Web services. In accordance with the embodiment of the present invention shown in FIG. 4, the costly steps of serialization, encoding, callout to the WSP, and decoding shown in FIG. 2 are not required for every SOAP request because certain SOAP response messages are cached. With reference to FIG. 4, after the corresponding SOAP response message has been obtained a first time by the portal server 5, it is stored in the memory element 56 by the storage engine 50. Subsequently, when a request from a user corresponds to the method and parameters of a previous request, the Call Object Invocation component 51 causes the storage engine 50 to read the corresponding stored SOAP object from memory element 56, as indicated by arrow 59. The SOAP object read out of memory element 56 is forwarded by the storage engine 50 to the SOAP Serializer/Deserializer 58, which then deserializes the SOAP object and returns the expected value, i.e., the corresponding application object to the portal application.

The Call Object Invocation process 51 shown in FIG. 4 may be substantially the same as, or identical to, the Call Object Invocation process 19 shown in FIG. 2. As in FIG. 2, the Call Object Invocation process 51 of FIG. 4 instantiates the client, or call, object 52, obtains the WSDL file 53 that corresponds to the user request, obtains the corresponding service method name and method parameters 54 from the WSDL file 53, and outputs a corresponding service method call 55. However, in accordance with the embodiment shown in FIG. 4, this service method call is sent to the storage engine 50, which maps the service method call into the memory address of the corresponding SOAP object in memory element 56.

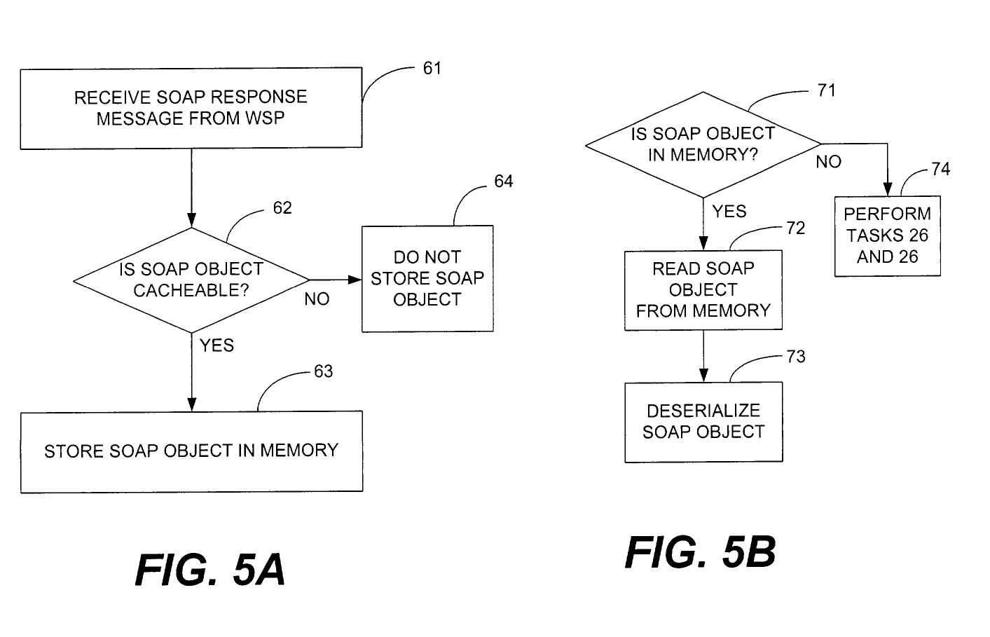

FIGS. 5A and 5B are flow charts demonstrating the methods of the present invention in accordance with the embodiment of FIG. 4 for caching SOAP objects and for servicing requests, respectively. The flow charts shown in FIGS. 5A and 5B assume that a first request for a cacheable response has previously been made and that the corresponding SOAP object has been sent to the consumer side by the WSP. Therefore, the first step shown in the flow chart is to receive the SOAP response message from the corresponding WSP, as indicated by block 61. The second step, which is optional, is to determine whether the corresponding SOAP object is cacheable, as indicated by decision block 62. Alternatively, every SOAP object could be stored and a subsequent determination can be made as to whether a SOAP object read from memory is potentially unreliable, thus causing a new SOAP request message to be sent to the WSP.

If a determination is made at block 62 that the SOAP object is cacheable, the SOAP object is stored in memory element 56, as indicated by block 63. If a determination is made that the SOAP object is not cacheable, the SOAP object is not stored, as indicated by block 64. The various ways in which determinations can be made as to whether a particular SOAP object should be cached will be discussed below in more detail.

With reference to FIG. 5B, when a client request is made, a determination is made as to whether the corresponding SOAP response object is available in memory, as indicated by decision block 71. If so, the SOAP object is read from memory, as indicated by block 72. The SOAP object is then deserialized, as indicated by block 73, into the corresponding application object. If not, the normal processing steps 26 and 27 shown in FIG. 2 are performed. It should be noted that prior to, or in lieu of, the step represented by block 71, a determination could be made as to whether the request corresponds to a cacheable SOAP response. If it does not, then steps 71-73 would be avoided and the normal processing steps 26 and 27 would be performed.

Because the processes represented by circles 26, 27 and 46 and the HTTP request 30 in FIG. 2 do not need to be performed when the desired SOAP object is located in memory element 56, a large amount of processing overhead is avoided, which accelerates the requested Web service. Of course, the first time that the particular request is made, the processes represented by circles 26, 27 and 46 and HTTP request 30 are performed. These processes are also performed if the request does not correspond to a SOAP response that should be cached. For example, some Web services requests relate to information that is only accurate for a certain amount of time, such as real time weather conditions and stock quotes. In these cases, the SOAP objects may not be cached, or they may be cached only for particular periods of time, i.e., until the information is deemed to be potentially unreliable.

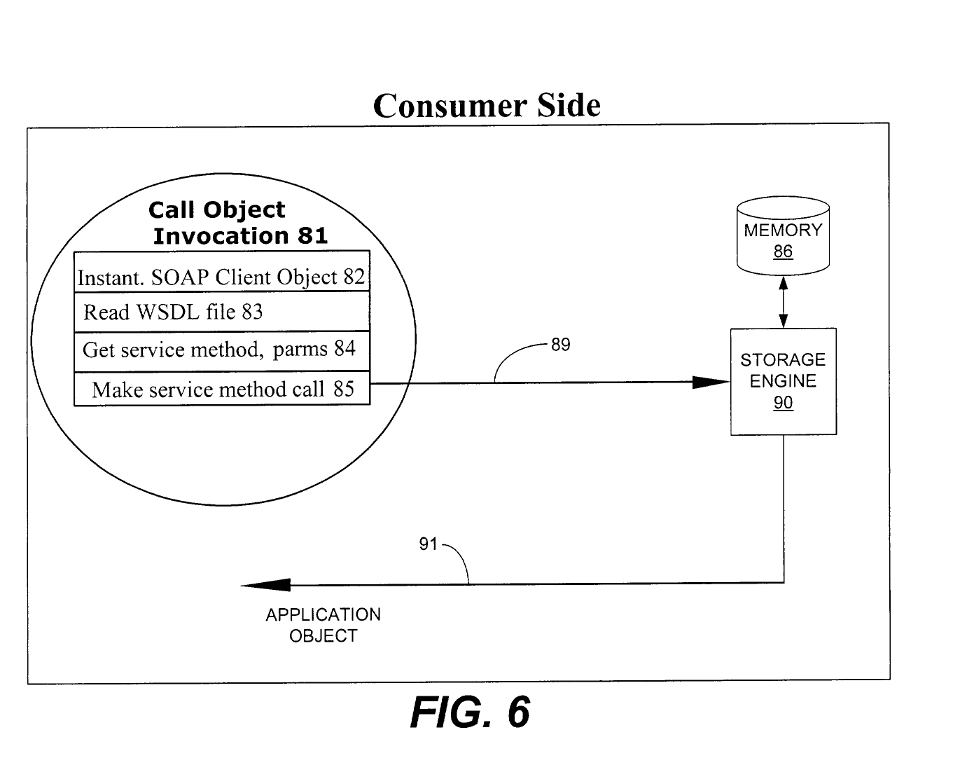

FIG. 6 is another embodiment of the consumer side components/processes that enable certain processes shown in FIG. 2 to be avoided. Specifically, processes 26, 27, 46 and 47 and the HTTP request 30 are avoided. In accordance with this embodiment of the present invention, deserialized application objects as opposed to SOAP objects are cached. A comparison of FIGS. 4 and 5 reveals that the process 58 in FIG. 4 of deserializing the SOAP object to produce an application object is avoided when the application object rather than the SOAP object is cached. In FIG. 6, the Call Object Invocation component 81 maybe substantially the same as, or identical to, the Call object Invocation component 51 shown in FIG. 4. Similarly, processes 82, 83, 84 and 85 may be substantially the same as, or identical to, processes 52, 53, 54 and 55, respectively, shown in FIG. 4. Therefore, a discussion of component 81 or of processes 82-85 will not be provided in the interest of brevity. Rather, only the interaction between the Call Object Invocation component 81, the storage engine 90 and memory element 86 will be described.

When the service method call is output to the storage engine 90, as indicated by arrow 89, storage engine 90 attempts to locate the corresponding application object in memory element 86. The storage engine 90 accomplishes this task by mapping the service method call into the memory address at which the corresponding application object is stored in memory element 86. As indicated by arrow 91, the application object that is read out of memory is returned to the application program being executed at the consumer-side server (not shown).

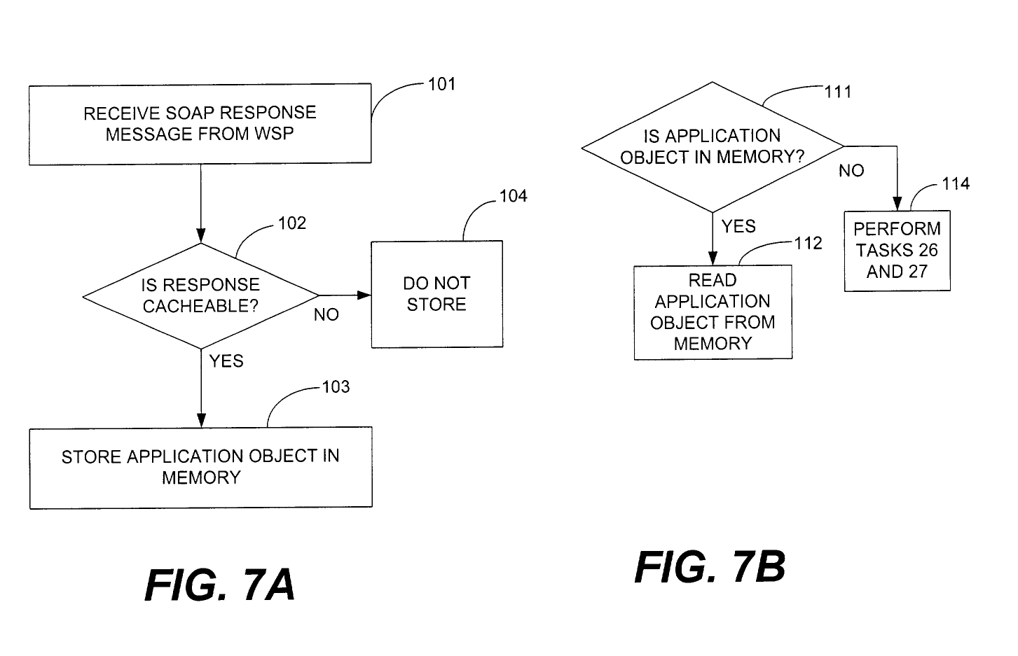

FIGS. 7A and 7B are flow charts demonstrating the methods of the present invention in accordance with the embodiment of FIG. 6 for caching application objects and for servicing requests, respectively. The flow charts shown in FIGS. 7A and 7B assume that a first request for a cacheable response has previously been made and that the corresponding SOAP response message has been sent to the consumer side by the WSP. Therefore, the first step shown in the flow chart is to receive the SOAP response message from the corresponding WSP, as indicated by block 101. The second step, which is optional, is to determine whether the corresponding application object is cacheable, as indicated by decision block 102. Alternatively, every application object could be stored and a subsequent determination could be made as to whether an application object read from memory is potentially unreliable, in which case a new SOAP request message would be sent to the WSP.

If a determination is made at block 102 that the application object is one that should be cached, the application object is stored in memory element 86 (FIG. 6), as indicated by block 103. If a determination is made that the application object should not be cached, the application object is not stored, as indicated by block 104. The various ways in which determinations can be made as to whether a particular application object should be cached will be discussed below in more detail.

With reference to FIG. 7B, when a client request is made, a determination is made as to whether the corresponding application response object is available in memory, as indicated by decision block 111. If so, the application object is read from memory, as indicated by block 112, and provided to the server application. The step of deserialization 73 in FIG. 5B is not necessary in accordance with this embodiment. If the application object is not in memory, the normal processing steps 26 and 27 shown in FIG. 2 are performed. It should be noted that prior to, or in lieu of, the step represented by block 111, a determination could be made as to whether the request corresponds to an application object that should be cached. If it does not, then steps 111 and 112 would be avoided and the normal processing steps 26 and 27 shown in FIG. 2 would be performed.

Because the processes represented by circles 26, 27, 46 and 47 and HTTP request 30 shown in FIG. 2 do not need to be performed when the desired application object is located in memory element 86, a large amount of processing overhead is avoided, which accelerates the requested Web service. Of course, the first time that the particular request is made, the processes represented by circles 26, 27, 46 and 47 and HTTP request 30 are performed. These processes are also performed if the request does not correspond to a SOAP response message that should be cached. As stated above, some Web services requests relate to information that is only accurate for a certain amount of time, such as real time weather conditions and stock quotes. In these cases, the application objects may not be cached, or they may be cached only for particular periods of time, i.e., until the information is deemed to be potentially unreliable.

Either a “tag-based” approach or a “tagless” approach preferably is used to enable determinations to be made as to whether a SOAP or application object should be cached. With the tag-based approach, one or more tags are inserted into the application code (e.g., the portal application code being executed by the portal server 5 to identify methods associated with objects that should be cached). The storage engines 50 and 90, depending on which embodiment is being implemented, preferably use the tags as keys that are mapped by the storage engine into the memory addresses at which the associated SOAP objects or application objects are stored. The tag-based approach is disclosed in U.S. patent application Ser. No. 09/722,260, which is incorporated herein in its entirety.

With the tagless approach, cacheable services are specified in a “cacheable services” file that is separate from the application code. This is advantageous in that it makes it unnecessary to modify the application code to include tags. Therefore, the tagless approach is preferred over the tag-based approach. Therefore, the example embodiments of the present invention will be described only with reference to the tagless approach for purposes of brevity and ease of illustration. Those skilled in the art will understand, in view of the discussion provided herein the manner in which either approach can be implemented to accomplish the objectives of the present invention.

With the tagless approach, keys that can be mapped into memory addresses may be generated as follows:

Key=URL#Method Name#Parameter List

where “URL” is the SOAP address location as specified in the WSDL file, “Method Name” is the portType operation name as specified in the WSDL file, “Parameter List” is the concatenated run-time parameter values and “#” is a delimiter. This key uniquely identifies a SOAP request. Keys preferably are generated dynamically at run-time when a SOAP request is created by the consumer. The elements used in the key generation process preferably correspond to elements in the WSDL associated with the particular service requested. For example, the code in the box below corresponds to the WSDL for a stock quote service, and the elements in bold correspond to the elements used to generate the key.

```
<?xml version=“1.0” ?>
  <definitions targetNamespace=“http://www.ibm.com/namespace/wsif/
  samples/stockquote-interface”
        xmlns:tns=“http://www.ibm.com/namespace/wsif/samples/
        stockquote-interface”
        xmlns:xsd=“http://www.w3.org/1999/XMLSchema”
        xmlns=“http://schemas.xmlsoap.org/wsdl/”>
  <message name=“GetQuoteInput”>
    <part name=“symbol” type=“xsd:string”/>
  </message>
  <message name=“GetQuoteOutput”>
    <part name=“quote” type=“xsd:float”/>
  </message>
  <portType name=“StockquotePT”>
    <operation name=“getQuote”>
    <input message=“tns:GetQuoteInput”/>
    <output message=“tns:GetQuoteOutput”/>
    </operation>
  </portType>
  <binding name=“SOAPBinding” type=“tns-int:StockquotePT”>
    <soap:binding style=“rpc” transport=“http://schemas.xmlsoap.org/
    soap/http”/>
    <operation name=“getQuote”>
    <soap:operation soapAction=“http://example.com/GetTradePrice”/>
    <input>
      <soap:body use=“encoded”
        namespace=“urn:xmltoday-delayed-quotes”
        encodingStyle=“http://schemas.xmlsoap.org/soap/encoding/”/>
    </input>
    <output>
      <soap:body use=“encoded”
        namespace=“urn:xmltoday-delayed-quotes”
        encodingStyle=“http://schemas.xmlsoap.org/soap/encoding/”/>
    </output>
    </operation>
  </binding>
  <service name=“StockquoteService”>
    <documentation>Stock quote service</documentation>
    <port name=“GetStockQuotePort” binding=“tns:SOAPBinding”>
    <soap:address location=“http://stockqote.com/soap/servlet/
    rpcrouter”/>
    </port>
  </service>
  </definitions>
```

The soap address location is “http://stockquote.com/soap/servlet/rpcrouter”, which corresponds to the WSP URL. The port type operation name “getQuote” corresponds to the Method Name. The parameter values are not shown in the WSDL because they are only known at run-time. In this example, the parameter value is represented by “symbol.”

Preferably, additional metadata will be associated with cacheable services, such as a time-to-live (TTL) indicator, for example. A TTL indicator may be used, for example, to indicate that a cached object is valid for five minutes. This may be appropriate where the service is a stock quote due to the fact that stock prices often change frequently. This type of metadata can be specified in the cacheable services file. Thus, the cacheable services file for the portal example may appear as shown in Table 1.

TABLE 1

| | Method | Parameter | |
|---|---|---|---|
| URL | Name | List | TTL (sec) |
| http://stockquote.com/soap/ | GetQuote | Symbol | 30 |
| servlet/rpcrouter | | | |
| http://weather.com/soap/servlet/ | GetWeather | ZipCode | 1800 |
| rpcrouter | | | |
| http://news.com/soap/servlet/ | GetNews | Category, | 3600 |
| rpcrouter | | zipCode | |

The basic structure of the cache (i.e., memory element 50 or 90) is shown in Table 2.

TABLE 2

| Attribute | Description |
|---|---|
| Key | URL#Method Name#Parameter List |
| Content | Object |
| Metadata | Any needed metadata, e.g., time-to-live |

The cache can store any type of object, e.g., programmatic objects, SOAP messages, etc. Referring again to the earlier example of a user requesting a portal page, an example of the manner in which a stock quote service invocation may occur in accordance with the present invention will now be provided. In this example, the stock quote service output is cacheable. The following code is sample Java code that may be used to invoke the stock quote service.

```
public class GetQuote {
  public static void main (String[] args) throws Exception {
  // Get input arguments...
  // Process the arguments...
  // Build the call.
  Call call = new Call ( );
  call.setTargetObjectURI (“urn:xmltoday-delayed-quotes”);
  call.setMethodName (“getQuote”);
  call.setEncodingStyleURI(encodingStyleURI);
  Vector params = new Vector ( );
  Params.addElement (new Parameter(“symbol”, String.class, symbol,
  null));
  call.setParams (params);
  // make the call
  // this method is overloaded by the SOAP Client Library
  Response resp = call.invoke (/* router URL */ url, /* actionURI */ “”);
  // Check the response.
  if (resp.generatedFault ( )) {
    Fault fault = resp.getFault ( );
    System.out.println (“Ouch, the call failed: ”);
    System.out.println (“ Fault Code = ” + fault.getFaultCode ( ));
    System.out.println (“ Fault String = ” + fault.getFaultString ( ));
    } else {
    Parameter result = resp.getReturnValue ( );
  // Perform additional logic to generate the application object...
  }
  }
}
```

As this code sample shows, the Java version of the application code creates a call object, which contains the necessary information to invoke the service request, including the service URL, method name, and parameters. The “call.invoke” method packages the call 5 object as a SOAP object, sends the request to the corresponding WSP, and instantiates the response object “resp”. This method also checks the cache for the requested object. The following is pseudocode for the call.invoke method.

```
// generate the service key
serviceKey = URL#MethodName#Parameter List
isCacheable = FALSE
// check cacheable services file to see if service is cacheable
If cacheableServices.isCacheable(serviceKey)
          IsCacheable = TRUE
          // check the cache
          If !(ObjectCache.get(serviceKey)) // not in cache
                    Package call as SOAP request
                    send SOAP request to Service Provider
                    get SOAP response
                    // insert into cache
                    ObjectCache.set(serviceKey, content, metadata)
Else // service not cacheable
package call as SOAP request
          send SOAP request to Service Provider
          get SOAP response
```

As this pseudocode shows, the first step in this method is to generate the key (“serviceKey”) for the SOAP request. This is possible because the call object contains all the necessary information to uniquely identify a SOAP request (i.e., the URL, Method Name, and Parameter List). The serviceKey is used to check the cacheable services file. It should be noted that while this information preferably is initially specified in a file, it may be read into an in-memory structure at run-time for efficiency.

If the service is cacheable, then the serviceKey is used to lookup the object in cache. If the object is in cache, then it is retrieved from the cache and the service invocation is bypassed. If the object is not in cache, then the usual service invocation occurs, as discussed above, and the object is inserted into the cache, along with its corresponding serviceKey.

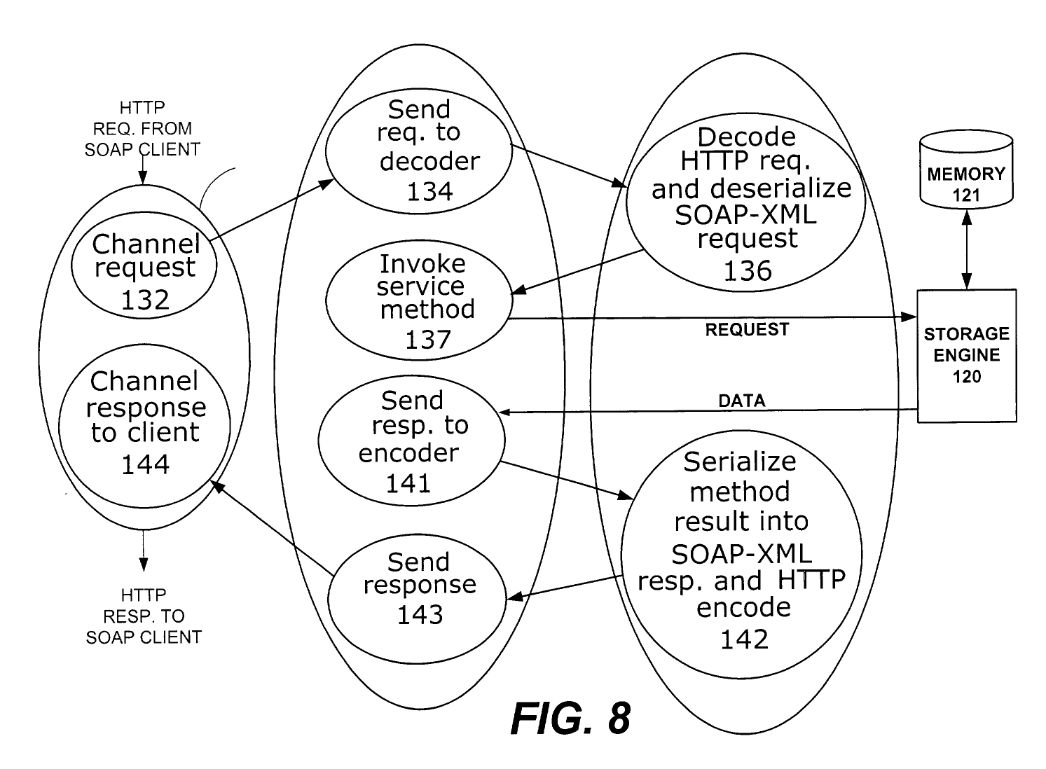

In accordance with another embodiment of the present invention, SOAP response messages are cached at the WSP. As discussed in detail above with reference to FIG. 3, a large amount of processing overhead is associated with the tasks performed at the WSP in order to generate a SOAP response and send the SOAP response to the corresponding consumer-side location. FIG. 8 is a block diagram of logic located at the WSP that receives the SOAP request message and generates and outputs a SOAP response message. In accordance with the embodiment of the present invention shown in FIG. 8, a storage engine 120 located at the WSP caches response objects that are cacheable in memory element 121. Therefore, when a SOAP request is received, many of the processing steps shown in FIG. 3 can be eliminated if the corresponding SOAP response is in memory element 120.

The components 131, 133 and 135 preferably perform the same operations as components 31, 33 and 35, respectively, in FIG. 3. Therefore, a detailed discussion of the functions of these components will not be provided herein. Similarly, processes 132, 144, 134, 137, 141, 143, 136, 142 preferably are the same as processes 32, 44, 34, 37, 41, 43, 36, 42, respectively, in FIG. 3. Therefore, a detailed discussion of these processes will not be provided herein. The run service method logic 38 in FIG. 3 has been eliminated from the WSP shown in FIG. 8 to indicate that it does not execute when the requested object is found in cache. If the requested object is not found in cache, the run service method logic executes and performs the corresponding service method.

In order to read a requested object from cache (i.e., from memory element 121), storage engine 120 utilizes a key such as that discussed above to map the service method request into a memory address corresponding to a location in memory element 121 at which the corresponding service method response is stored. The storage engine 120 then simply reads the cached response out of memory element 121 and it is subsequently processed by processes 141, 142, 143 and 144 in the manner discussed above with reference to FIG. 3 and processes 41, 42, 43 and 44, respectively. Therefore, the processing overhead normally incurred when the run service method logic 38 (FIG. 3) performs the service method has been eliminated and the overall processing overhead incurred by the WSP of FIG. 8 in performing the service method is greatly reduced.

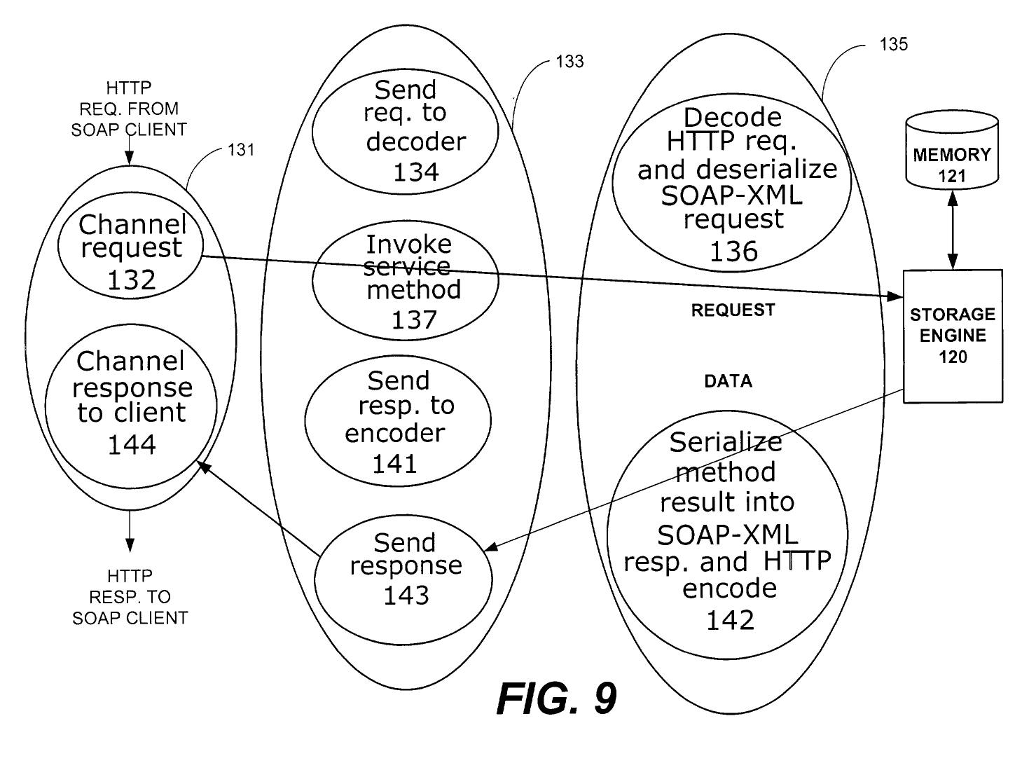

In accordance with the embodiment of FIG. 8, unserialized SOAP responses are stored in memory element 121. This is why processes 141 and 142 are performed. In accordance with the embodiment of FIG. 9, serialized SOAP-XML objects that have been encoded in HTTP are stored in memory element 121. The embodiment of FIG. 9 takes advantage of the ability to “stuff” arbitrary content into HTTP headers. This feature is made possible in accordance with the present invention by adding a method to the SOAP invocation object that will add an HTTP header. For example, the following method may be added to the call object: addHttpHeader (“name”, “value”). There are many ways in which this feature may be used. For example, the call object addHeader (“serviceKey”, “http://stockquote.com/soap/servlet/#getQuote#symbol=ORCL”) could store the key associated with the SOAP response in the HTTP header. This header is used by the storage engine 120 to efficiently lookup the corresponding response object cached in memory element 121. This obviates the need for the storage engine 120 to scan the SOAP request message, which would require that steps 134 and 136 in FIG. 8 be performed.

The HTTP header may also be used to store user-specific information, such as cookies or security tokens, for example. This could improve the performance of existing authentication schemes, which require extracting the SOAP message in order to authenticate. By stuffing this information in the header, the overhead of parsing the SOAP message for the purpose of authentication is eliminated.

Another feature of the present invention is that it enables alternative services to be specified. With Web services, it may often be the case that one service can be substituted for another transparently. For example, the same stock quote can perhaps be obtained from multiple providers (e.g., Yahoo Finance, PC Quote). If this information is known, then it can be specified in the cacheable services file. At run-time, such services can be substituted if needed. For example, if the object corresponding to a stock quote request from Yahoo Finance is not found in cache, but that an “equivalent” object is found in cache from the PC Quote Service Provider, this object can be returned in place of the requested object. This substitution would eliminate the need for a Web services call to the Yahoo Finance WSP.

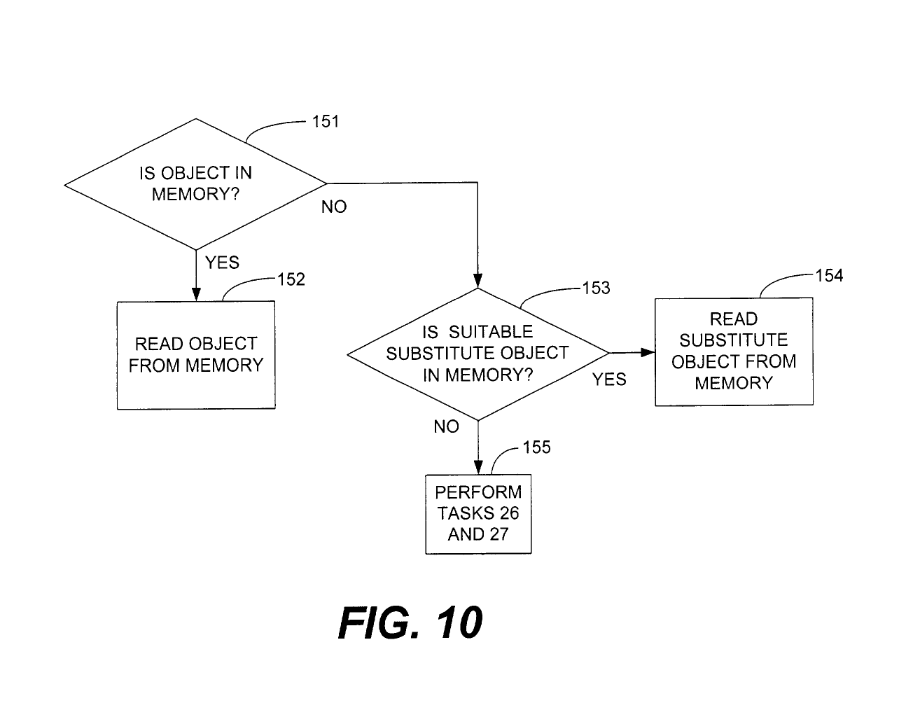

The flow chart of FIG. 10 demonstrates the manner in which the substitution method might be performed. The first step is to determine whether the desired object is in cache, as indicated by block 151. If the desired object is found in cache, the object is read out, as indicated by block 152. If the object is not in cache, a determination is made as to whether a suitable substitute object is in cache, as indicated by block 153. If so, the substitute object is read out, as indicated by block 154. If not, processes 26 and 27 (and perhaps the entire sequence of processes) discussed above with reference to FIG. 2 are performed.

It should be noted that the present invention has been described with reference to particular embodiments for example purposes and that the present invention is not limited to these embodiments. Those skilled in the art will understand, in view of the discussion provided herein, that variations and modifications may be made to the embodiments described above, and that all such changes are within the scope of the present invention. Also, the memory used for cache in accordance with the present invention is not limited to any particular type of memory or location for the memory. Also, the present invention will work with any transport protocol that supports SOAP, such as, for example, HTTP, SMTP, JMS, etc. Only the HTTP protocol has been discussed herein because it is the most commonly used transport protocol. Other protocols have not been discussed herein in the interest of brevity and because persons skilled in the art will understand in view of the discussion provided herein the manner in which other protocols could be employed with the present invention. Those skilled in the art will understand that these considerations depend on the particular manner in which the present invention is implemented.

What is claimed is:

1. An apparatus for accelerating web services, the apparatus being coupled to a network to enable the apparatus to communicate over the network, the apparatus comprising:
call object invocation logic, the call object invocation logic receiving a request for a web service and converting the request into a service method call;
storage engine logic, the storage engine logic receiving information from the call object invocation logic corresponding to the service method call and using at least a portion of the information to determine whether a response to the request is stored in a memory element, wherein if the storage engine logic determines that the response is stored in the memory element, the storage engine logic causes the response to be read from the memory element.

2. The apparatus of claim 1, wherein the apparatus comprises the memory element.

3. The apparatus of claim 1, wherein the response contained in the memory element corresponds to a Simple Object Access Protocol (SOAP), extensible markup language (XML) object (SOAP-XML object).

4. The apparatus of claim 1, wherein the response stored in the memory element corresponds to an application object.

5. The apparatus of claim 1, further comprising:
simple Object Access Protocol (SOAP) serializer logic, wherein if the storage engine logic determines that the response is not contained in the memory element, the serializer logic serializes the service method call information into a SOAP, extensible markup language (XML) request (SOAP-XML request).

6. The apparatus of claim 5, further comprising:
hypertext (HTTP) wrapping logic, the HTTP wrapping logic receiving the SOAP-XML request and wrapping the SOAP-XML request in an HTTP wrapper to produce an HTTP request message, the apparatus outputting the HTTP request message onto the network to be sent to a Web Service Provider (WSP).

7. The apparatus of claim 6, further comprising:
SOAP-XML extraction logic, the SOAP-XML extraction logic receiving an HTTP response from the WSP, the HTTP response being wrapped in an HTTP wrapper, the SOAP-XML extraction logic extracting a SOAP-XML response from the HTTP response.

8. The apparatus of claim 7, further comprising:
deserializing logic, the deserializing logic receiving the extracted SOAP-XML response and deserializing the SOAP-XML response to produce an application object.

9. The apparatus of claim 8, further comprising:
caching determination logic, the caching determination logic receiving and analyzing the application object to determine whether the application object corresponds to a response that should be stored in the memory element, wherein if the caching logic determines that the application object corresponds to a response that should be stored in the memory element, the storage engine logic causes the response to be stored in the memory element.

10. The apparatus of claim 3, further comprising:
deserializing logic, the deserializing logic receiving the SOAP-XML object read from the memory element by the storage engine logic and deserializing the received SOAP-XML object to produce an application object.

11. The apparatus of claim 1, wherein if the storage engine logic determines that the response is not stored in the memory element, the storage engine logic determines whether a substitute response is stored in the memory element, wherein if the storage engine logic determines that a substitute response is stored in the memory element, the storage engine logic causes the substitute response to be read from the memory element.

12. A method for accelerating web services in a network, the method comprising:
receiving a request for a web service and converting the request into a service method call;
utilizing information relating to the service method call to determine whether a response to the request is stored in a memory element; and
wherein if a determination is made that a response to the request is stored in the memory element, reading the response from the memory element.

13. The method of claim 12, wherein the response stored in the memory element corresponds to a Simple Object Access Protocol (SOAP), extensible markup language (XML) object (SOAP-XML object).

14. The method of claim 12, wherein the response stored in the memory element corresponds to an application object.

15. The method of claim 12, further comprising:
wherein if a determination is made that the response is not stored in the memory element, serializing the service method call information into a Simple Object Access Protocol (SOAP), extensible markup language (XML) request (SOAP-XML object);
wrapping the SOAP-XML request in a hypertext (HTTP) wrapper to produce an HTTP request message; and
outputting the HTTP request message onto the network to be sent to a Web Service Provider (WSP).

16. The method of claim 15, further comprising:
receiving an HTTP response sent by the WSP in response to the WSP receiving the HTTP request message, the HTTP response message being wrapped in an HTTP wrapper; and
extracting a SOAP-XML response from the HTTP response message.

17. The method of claim 16, further comprising:
deserializing the SOAP-XML response to convert the SOAP-XML response into an application object.

18. The method of claim 17, further comprising:
analyzing the application object to determine whether the application object corresponds to a response that should be stored in the memory element; and
wherein if a determination is made that the application object corresponds to a response that should be stored in the memory element, storing the response in the memory element.

19. The method of claim 18, wherein the response being stored in the memory element is a SOAP object.

20. The method of claim 18, wherein the response being stored in the memory element is an application object.

21. The method of claim 13, further comprising:
deserializing the SOAP-XML object read from the memory element to produce an application object.

22. The method of claim 12, further comprising:
wherein if a determination is made that the response is not stored in the memory element, determining whether a substitute response is stored in the memory element; and
wherein if a determination is made that a substitute response is stored in the memory element, reading the substitute response from the memory element.

23. An apparatus for accelerating web services, the apparatus being located at a Web Service Provider (WSP) and being coupled to a network to enable the apparatus to communicate over the network, the apparatus comprising:
request processing logic, the request processing logic receiving a service method request and decoding the service method request;
storage engine logic, the storage engine logic receiving information relating to the decoded service method request from the request processing logic and using at least a portion of the information to determine whether a response to the service method request is stored in a memory element, wherein if the storage engine logic determines that the response is stored in the memory element, the storage engine logic causes the response to be read from the memory element.

24. The apparatus of claim 23, wherein the apparatus comprises the memory element.

25. The apparatus of claim 23, wherein the response contained in the memory element corresponds to a Simple Object Access Protocol (SOAP), extensible markup language (XML) object (SOAP-XML object).

26. The apparatus of claim 23, wherein the response stored in the memory element corresponds to an application object.

27. The apparatus of claim 23, further comprising:
simple Object Access Protocol (SOAP) serializer logic, wherein the serializer logic serializes the response read out of the memory element into a SOAP, extensible markup language (XML) response (SOAP-XML response); and
hypertext (HTTP) wrapping logic, the HTTP wrapping logic receiving the SOAP-XML response and wrapping the SOAP-XML response in an HTTP wrapper to produce an HTTP response message, the apparatus outputting the HTTP response message onto the network to be sent to a machine coupled to the network that sent the service method request to the WSP.

28. A method for accelerating web services in a network, the method comprising:
receiving a service method request for a web service at a Web Service Provider (WSP) and decoding the service method request;
utilizing information relating to the decoded service method request to determine whether a response to the request is stored in a memory element; and
wherein if a determination is made that a response to the request is stored in the memory element, reading the response from the memory element.

29. The method of claim 28, wherein the response stored in the memory element corresponds to a Simple Object Access Protocol (SOAP), extensible markup language (XML) object (SOAP-XML object).

30. The method of claim 28, wherein the response stored in the memory element corresponds to an application object.
